(19) United States
(12) Patent Application Publication
(10) Pub. No.: US 2017/0320786 A1
(43) Pub. Date: Nov. 9, 2017

(54) FISH SOLUBLE BY-PRODUCT AND GRAIN BY-PRODUCT BASED ORGANIC FERTILIZER

(71) Applicant: True Organic Products, Inc., Helm, CA (US)

(72) Inventor: Jacob Matthew Evans, Pebble Beach, CA (US)

(73) Assignee: True Organic Products, Inc., Helm, CA (US)

(21) Appl. No.: 15/150,047

(22) Filed: May 9, 2016

(51) Int. Cl. C05F 5/00; C05F 1/00

(52) U.S. Cl. CPC C05F 5/00; C05F 5/004; C05F 1/002; C05F 5/002

(57) ABSTRACT

A process for production of fish soluble by-product based organic fertilizer includes combining fish soluble by-product and one or more grain by-products to create a combination of fish soluble by-product and one or more grain by-products. The combination of fish soluble by-product and one or more grain by-products yields the fish soluble by-product based organic fertilizer product.

### BACKGROUND

Over the years, a number of different types of fertilizer compositions have been developed and employed in agriculture. In the recent past, synthetic chemical fertilizer compositions dominated the fertilizer marketplace. More recently, however, the public has become increasingly aware and concerned about the links between synthetic chemical fertilizer use, environmental degradation, and human illness. For instance, the public has recently become more aware that synthetic chemical fertilizers contain poisons, pollute water, destroy microbes in the soil, lose half their value due to runoff, burn roots, require significant amounts of water, contain less micro-nutrition, and are heavily laden with salt.

Consequently, there has been a significant movement toward fertilizer compositions that are suitable for use in United States Department of Agriculture certified organic crop production. These fertilizer compositions are typically derived from natural sources and do not rely on synthetic chemicals. Unlike synthetic products, organic fertilizers encourage the growth of micro-organisms, which break down old plant material and convert nutrients into food. Consequently, over time, the use of organic fertilizers results in healthier and more fertile soil, which leads to hardier and more robust plants.

Furthermore, consumers are more concerned about health and the environment than ever before and are making purchasing decisions based upon those concerns. As a result, more and more consumers are purchasing organic foods. Studies show that many consumers who purchase organic foods do so because they wish to avoid toxic and persistent pesticides and fertilizers.

As a result of the increased demand for organic fertilizer compositions, there is significant interest in developing better organic fertilizer compositions that provide nutrients and reduce the risk of introducing pathogens into the food supply.

Desirable nutrients include, but are not limited to, bioavailable phosphorous, potassium, and nitrogen. These nutrients must not only be present in the fertilizer, but also must be present in sufficient concentrations to benefit agricultural vegetation. In addition, the organic fertilizer compositions must be in a form that is readily applied to the agricultural vegetation and/or has minimum impact on the surrounding community. To this end, the desirable characteristics of organic fertilizer compositions include, but are not limited to, the following: the ability to directly apply the organic fertilizer compositions in a low viscosity liquid form; the ability to inject and/or add the organic fertilizer compositions into irrigation streams; time-released nitrogen components, which become bioavailable to agricultural vegetation by beneficial microbial digestion in soil; minimized chemical crop burning; minimal odor associated with the organic fertilizer composition during and/or after application; and minimized undesirable runoff.

There is a current need for an environmentally benign fertilizer derived from a natural organic source that provides sufficient levels of usable nutrients but does not require significant processing and does not raise environmental concerns.

### SUMMARY

In accordance with one embodiment, a process of manufacturing a fish soluble by-product based organic fertilizer product is disclosed. The Inventor developed the embodiments disclosed herein due, in part, to his dissatisfaction with a fish by-product currently prevalent in organic fertilizers: enzyme digested fish.

In the past, attempts have been made to create organic fertilizer products out of enzyme digested fish, also known as fish hydrolysate or “liquid fish.” Enzyme digested fish is created by adding an enzyme that virtually “dissolves” fish by-products into an enzyme digested fish solution. Fish itself is composed mostly of water and the dissolution process results in a resultant enzyme digested fish solution that is typically 80 percent or more water. Since the solution is primarily water, the concentrations of desirable nutrients, particularly nitrogen, in the enzyme digested fish is quite low. In addition, the enzyme digested fish has an extremely strong and unpleasant odor. Consequently, the use of any fertilizer utilizing enzyme digested fish is often restricted to areas far removed from human communities. However, with the encroachment of human communities on virtually all farm lands throughout the world, farming locations that are sufficiently removed from human communities to allow for the non-problematic use of enzyme digested fish are becoming more and more rare.

Given the low-nutrient value and odor associated with enzyme digested fish, the Inventor became interested in experimenting with another by-product of fish processing: fish soluble by-product. In one embodiment, fish soluble by-product is produced when whole fish and fish waste, including fish renderings, fish offal, and spoiled fish, is heated and pressed to remove liquid. After oil is extracted from the waste and some liquid is evaporated, the waste is optionally treated with acid to stabilize the compounds it contains. The resulting product is one example of fish soluble by-product.

Thus, fish soluble by-product can be produced from the waste that results from various fish processing industries such as fish canning, fish oil production, and fish meal industries. As a waste material, fish soluble by-product is readily available. Through a heating and concentration process, such as the process described above, fish soluble by-product has a higher percentage of nitrogen than does enzyme digested fish. Nonetheless, unlike enzyme digested fish, fish soluble by-product has been historically disfavored by the fertilizer industry because of its smell and thickness. Yet, the Inventor has discovered that when produced using the processes detailed in this disclosure, fertilizers from fish soluble by-product do not have as strong of an odor as is typically associated with enzyme digested fish and are of an appropriate viscosity for effective application.

In accordance with one embodiment, a process for production of fish soluble by-product based organic fertilizer includes combining fish soluble by-product and one or more grain by-products. In one embodiment, fish soluble by-product is obtained.

In one embodiment, one or more grain by-products are obtained. In various embodiments, the one or more grain by-products include, but are not limited to, corn steep liquor, a readily available by-product of corn wet-milling.

In one embodiment, the fish soluble by-product and the one or more grain by-products are combined to yield the fish soluble by-product based organic fertilizer product. In one embodiment, the fish soluble by-product is combined with the one or more grain by-products such that the resulting combination of fish soluble by-product and one or more grain by-products is 10 percent to 90 percent fish soluble by-product. In one embodiment, the fish soluble by-product is combined with the one or more grain by-products such that the resulting combination of fish soluble by-product and one or more grain by-products is 10 percent to 90 percent one or more grain by-products. In other embodiments, the fish soluble by-product is combined with one or more grain by-products such that the resulting combination of fish soluble by-product and one or more grain by-products is any desired percentage concentration of fish soluble by-product and one or more grain by-products.

In one embodiment, the combination of fish soluble by-product and one or more grain by-products is filtered to remove suspended particulate matter. In one embodiment, filtration is provided using a wire mesh size in a range of 50 to 200.

In one embodiment, the combination of fish soluble by-product and one or more grain by-products is aerated.

In one embodiment, the combination of fish soluble by-product and one or more grain by-products is optionally heat-treated. In one embodiment, the combination of fish soluble by-product and one or more grain by-products is heat-treated and, in one embodiment, optionally filtered to remove suspended particulate matter.

In one embodiment, the heat-treatment is performed in a range of about 130 to 200 degrees Fahrenheit (F) for up to 15 days.

In one embodiment, the heat-treated combination of fish soluble by-product and one or more grain by-products is cooled to yield the fish soluble by-product based organic fertilizer product.

In one embodiment, the heat-treated combination of fish soluble by-product and one or more grain by-products is filtered pre- and/or post-cooling. In one embodiment, filtration is provided using a wire mesh size in a range of 50 to 200.

In one embodiment, the fish soluble by-product based organic fertilizer product is applied to fields of agricultural vegetation in quantities in the approximate range of 5 to 900 gallons per acre. In one embodiment, the fish soluble by-product based organic fertilizer product disclosed herein is applied to the fields of agricultural vegetation either directly or by inclusion in an irrigation stream.

Using the process for production of a fish soluble by-product based organic fertilizer product disclosed herein, a fish soluble by-product based organic fertilizer product is provided that is environmentally benign; is non-pathogenic; is derived from a natural organic source; does not require significant processing; has minimal odor; has a low viscosity liquid form; can be applied directly to agricultural vegetation; can be injected and/or added into irrigation streams; includes time-released nitrogen components which become bioavailable to agricultural vegetation by beneficial microbial digestion in soil; and eliminates chemical crop burning.

As discussed in more detail below, using the below embodiments, with little or no modification and/or user input, there is considerable flexibility, adaptability, and opportunity for customization to meet the specific needs of various users under numerous circumstances.

### BRIEF DESCRIPTION OF THE DRAWINGS

FIG. 1 is a flow chart of a process for organic fertilization using a fish soluble by-product based organic fertilizer product, in accordance with one embodiment;

FIG. 2 is a flow chart of a process for creating a fish soluble by-product based organic fertilizer product from fish soluble by-product and one or more grain by-products, in accordance with one embodiment; and

FIG. 3 is a flow chart of a process for creating a fish soluble by-product based organic fertilizer product from fish soluble by-product and corn steep liquor, in accordance with one embodiment.

Common reference numerals are used throughout the figures and the detailed description to indicate like elements. One skilled in the art will readily recognize that the above figures are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying figures, which depict exemplary embodiments. Embodiments may be embodied in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

In accordance with one embodiment, a process for organic fertilization using fish soluble by-products includes creating a fish soluble by-product based organic fertilizer product and applying the fish soluble by-product based organic fertilizer product to agricultural vegetation and/or the fields/soil/substrate supporting the agricultural vegetation as a method of organic fertilization of the agricultural vegetation.

As used herein, the term “fish soluble by-product” includes a fish by-product that is produced when whole fish and fish waste, including fish renderings, fish offal, and spoiled fish, are heated and pressed to remove liquid. After oil is extracted from the waste and some liquid is evaporated, the waste is optionally treated with acid to stabilize the compounds it contains.

The term “grain by-product” includes by-products of grain processing including corn steep liquor, wet distillers grains, dried distillers grains with solubles, fermented grain solubles, corn condensed distillers solubles, and/or any other grain by-product as defined herein, known in the art at the time of filing, or developed thereafter. Corn steep liquor is a by-product of corn wet-milling and is readily available from corn processing activities. Comprised of soluble components of corn endosperm, corn steep liquor is relatively high in nutrients required for desirable plant growth, but has historically been used for livestock feed. The term corn steep liquor includes, but is not limited to, corn steepwater, light steepwater, heavy steepwater, and condensed fermented corn extractives.

As used herein, the term “organic fertilizer” means an ingredient or product that may be used in certified organic crop production in accordance with USDA National Organic Program standards.

Currently, 7 CFR 205.203 provides the practice standard for certified organic crop production. The regulations under 7 CFR 205.203 provide the following:

(a) The producer must select and implement tillage and cultivation practices that maintain or improve the physical, chemical, and biological condition of soil and minimize soil erosion.

(b) The producer must manage crop nutrients and soil fertility through rotations, cover crops, and the application of plant and animal materials.

(c) The producer must manage plant and animal materials to maintain or improve soil organic matter content in a manner that does not contribute to contamination of crops, soil, or water by plant nutrients, pathogenic organisms, heavy metals, or residues of prohibited substances. Animal and plant materials include:

(1) Raw animal manure, which must be composted unless it is:

(i) Applied to land used for a crop not intended for human consumption;
(ii) Incorporated into the soil not less than 120 days prior to the harvest of a product whose edible portion has direct contact with the soil surface or soil particles; Or

(iii) Incorporated into the soil not less than 90 days prior to the harvest of a product whose edible portion does not have direct contact with the soil surface or soil particles;

(2) Composted plant and animal materials produced through a process that:

(i) Established an initial C:N ratio of between 25:1 and 40:1; and

(ii) Maintained a temperature of between 131° F. and 170° F. for 3 days using an in-vessel or static aerated pile system; or

(iii) Maintained a temperature of between 131° F. and 170° F. for 15 days using a windrow composting system, during which period, the materials must be turned a minimum of five times.

(3) Uncomposted plant materials.

(d) A producer may manage crop nutrients and soil fertility to maintain or improve soil organic matter content in a manner that does not contribute to contamination of crops, soil, or water by plant nutrients, pathogenic organisms, heavy metals, or residues of prohibited substances by applying:

(1) A crop nutrient or soil amendment included on the National List of synthetic substances allowed for use in organic crop production;

(2) A mined substance of low solubility;

(3) A mined substance of high solubility: Provided, That, the substance is used in compliance with the conditions established on the National List of nonsynthetic materials prohibited for crop production;

(4) Ash obtained from the burning of a plant or animal material, except as prohibited in paragraph (e) of this section: Provided, That, the material burned has not been treated or combined with a prohibited substance or the ash is not included on the National List of nonsynthetic substances prohibited for use in organic crop production; and

(5) A plant or animal material that has been chemically altered by a manufacturing process: Provided, that, the material is included on the National List of synthetic substances allowed for use in organic crop production established in §205.601.

(e) The producer must not use:

(1) Any fertilizer or composted plant and animal material that contains a synthetic substance not included on the National List of synthetic substances allowed for use in organic crop production;

(2) Sewage sludge (biosolids) as defined in 40 CFR part 503; and (3) Burning as a means of disposal for crop residues produced on the operation: Except, That, burning may be used to suppress the spread of disease or to stimulate seed germination.

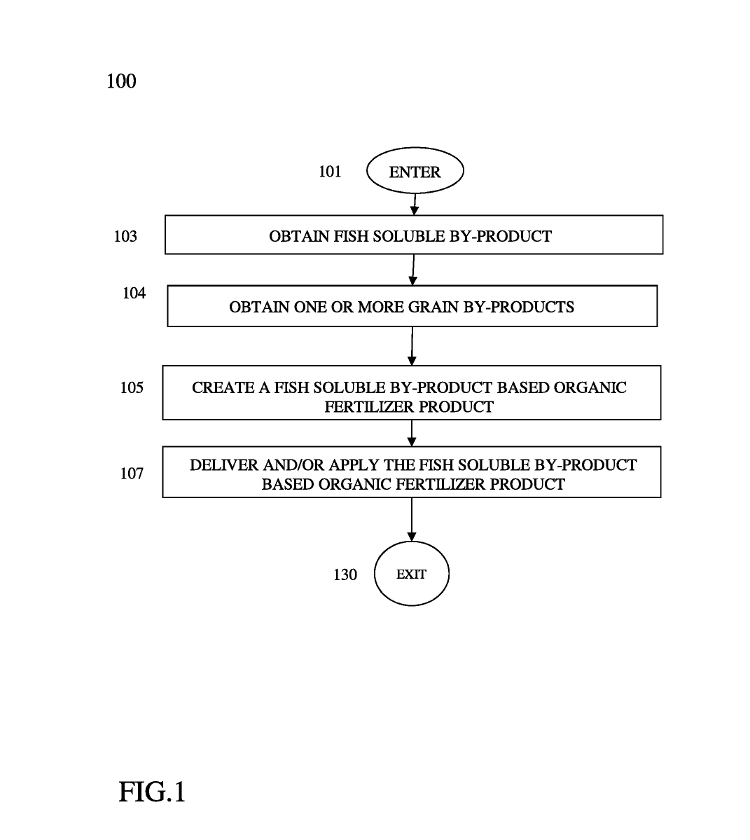

FIG. 1 shows a flow chart of a process for organic fertilization of agricultural vegetation using fish soluble by-product based organic fertilizer 100 in accordance with one embodiment. As shown in FIG. 1, the process for organic fertilization of agricultural vegetation using fish soluble by-product based organic fertilizer 100 begins at ENTER OPERATION 101 and process flow proceeds to OBTAIN FISH SOLUBLE BY-PRODUCT OPERATION 103.

In one embodiment, at OBTAIN FISH SOLUBLE BY-PRODUCT OPERATION 103, a quantity of fish soluble by-product is obtained. Fish soluble by-product includes a fish by-product resulting when whole fish and fish waste, including fish renderings, fish offal, and spoiled fish, is heated and pressed to remove liquid. After oil is extracted from the waste and some liquid is evaporated, the waste is optionally treated with acid to stabilize the compounds it contains.

In one embodiment, once a quantity of fish soluble by-product is obtained at OBTAIN FISH SOLUBLE BY-PRODUCT OPERATION 103, process flow proceeds to OBTAIN ONE OR MORE GRAIN BY-PRODUCTS OPERATION 104.

In one embodiment, at OBTAIN ONE OR MORE GRAIN BY-PRODUCTS OPERATION 104, a quantity of one or more grain by-products is obtained. In various embodiments, at least one of the one or more grain by-products includes corn steep liquor, wet distillers grains, dried distillers grains with solubles, fermented grain solubles, corn condensed distillers solubles, and/or any other grain by-product as defined herein, known in the art at the time of filing, or developed thereafter.

In one embodiment, once a quantity of one or more grain by-products is obtained at OBTAIN ONE OR MORE GRAIN BY-PRODUCTS OPERATION 104, process flow proceeds to CREATE A FISH SOLUBLE BY-PRODUCT BASED ORGANIC FERTILIZER PRODUCT OPERATION 105.

In one embodiment, at CREATE A FISH SOLUBLE BY-PRODUCT BASED ORGANIC FERTILIZER PRODUCT OPERATION 105, a fish soluble by-product based organic fertilizer product is created. In various embodiments, a fish soluble by-product based organic fertilizer is created by combining the fish soluble by-product of OBTAIN FISH SOLUBLE BY-PRODUCT OPERATION 103 and the one or more grain by-products of OBTAIN ONE OR MORE GRAIN BY-PRODUCTS OPERATION 104 to yield the fish soluble by-product based organic fertilizer product. In one embodiment, a fish soluble by-product based organic fertilizer is created by combining the fish soluble by-product of OBTAIN FISH SOLUBLE BY-PRODUCT OPERATION 103 and the one or more grain by-products of OBTAIN ONE OR MORE GRAIN BY-PRODUCTS OPERATION 104 to create a combination of fish soluble by-product and one or more grain by-products; optionally heat-treating the combination of fish soluble by-product and one or more grain by-products; and cooling the heat-treated combination of fish soluble by-product and one or more grain by-products to yield the fish soluble by-product based organic fertilizer product.

In one embodiment, once a fish soluble by-product based organic fertilizer product is created at CREATE A FISH SOLUBLE BY-PRODUCT BASED ORGANIC FERTILIZER PRODUCT OPERATION 105, process flow proceeds to DELIVER AND/OR APPLY THE FISH SOLUBLE BY-PRODUCT BASED ORGANIC FERTILIZER PRODUCT OPERATION 107.

In one embodiment, at DELIVER AND/OR APPLY THE FISH SOLUBLE BY-PRODUCT BASED ORGANIC FERTILIZER PRODUCT OPERATION 107, the fish soluble by-product based organic fertilizer product of CREATE A FISH SOLUBLE BY-PRODUCT BASED ORGANIC FERTILIZER PRODUCT OPERATION 105 is transferred in bulk to a tanker truck and/or disposed into drums for delivery of smaller quantities of the fish soluble by-product based organic fertilizer product. In one embodiment, at DELIVER AND/OR APPLY THE FISH SOLUBLE BY-PRODUCT BASED ORGANIC FERTILIZER PRODUCT OPERATION 107, the fish soluble by-product based organic fertilizer product of CREATE A FISH SOLUBLE BY-PRODUCT BASED ORGANIC FERTILIZER PRODUCT OPERATION 105 is then delivered to farms for application to agricultural vegetation.

In one embodiment, at DELIVER AND/OR APPLY THE FISH SOLUBLE BY-PRODUCT BASED ORGANIC FERTILIZER PRODUCT OPERATION 107, a quantity of the fish soluble by-product based organic fertilizer product of CREATE A FISH SOLUBLE BY-PRODUCT BASED ORGANIC FERTILIZER PRODUCT OPERATION 105 is offloaded into plastic field tanks located at or near the application site. In one embodiment, at DELIVER AND/OR APPLY THE FISH SOLUBLE BY-PRODUCT BASED ORGANIC FERTILIZER PRODUCT OPERATION 107, the plastic field tanks are then used to feed the fish soluble by-product based organic fertilizer product of CREATE A FISH SOLUBLE BY-PRODUCT BASED ORGANIC FERTILIZER PRODUCT OPERATION 105 into an irrigation stream either by direct injection or by vacuum drawing from the irrigation flow.

Depending on the particular agricultural vegetation requirements, the application rate of the fish soluble by-product based organic fertilizer product of CREATE A FISH SOLUBLE BY-PRODUCT BASED ORGANIC FERTILIZER PRODUCT OPERATION 105 at DELIVER AND/OR APPLY THE FISH SOLUBLE BY-PRODUCT BASED ORGANIC FERTILIZER PRODUCT OPERATION 107 may be anywhere in a range of approximately 5 to 900 gallons per acre.

In one embodiment, at DELIVER AND/OR APPLY THE FISH SOLUBLE BY-PRODUCT BASED ORGANIC FERTILIZER PRODUCT OPERATION 107 the fish soluble by-product based organic fertilizer product of CREATE A FISH SOLUBLE BY-PRODUCT BASED ORGANIC FERTILIZER PRODUCT OPERATION 105 may also be directly sprayed onto the agricultural vegetation without concerns of plant burning as may occur with more concentrated inorganic fertilizers.

In one embodiment, once the fish soluble by-product based organic fertilizer product of CREATE A FISH SOLUBLE BY-PRODUCT BASED ORGANIC FERTILIZER PRODUCT OPERATION 105 is delivered and applied at DELIVER AND/OR APPLY THE FISH SOLUBLE BY-PRODUCT BASED ORGANIC FERTILIZER PRODUCT OPERATION 107, process flow proceeds to EXIT OPERATION 130 and the process for organic fertilization of agricultural vegetation using fish soluble by-product 100 is exited.

Using the process for organic fertilization of agricultural vegetation using fish soluble by-product 100, contrary to conventional teachings, a fish soluble by-product based organic fertilizer product is provided that is environmentally benign; is non-pathogenic; is derived from natural organic sources; does not require significant processing; has minimal odor; has a low viscosity liquid form; can be applied directly to agricultural vegetation; can be injected and/or added into irrigation streams; includes time-released nitrogen components which become bioavailable to agricultural vegetation by beneficial microbial digestion in soil; and eliminates chemical crop burning.

In accordance with one embodiment, a process for production of a fish soluble by-product based organic fertilizer product includes combining fish soluble by-product, a by-product of fish processing with one or more grain by-products. In one embodiment, the combination of fish soluble by-product and one or more grain by-products is then heat-treated and, in one embodiment, optionally filtered to remove suspended particulate matter. In one embodiment, the heat-treated combination of fish soluble by-product and one or more grain by-products is then cooled to yield the fish soluble by-product based organic fertilizer product. In one embodiment, the fish soluble by-product based organic fertilizer product is then applied to agricultural vegetation, either directly or by inclusion in an irrigation stream.

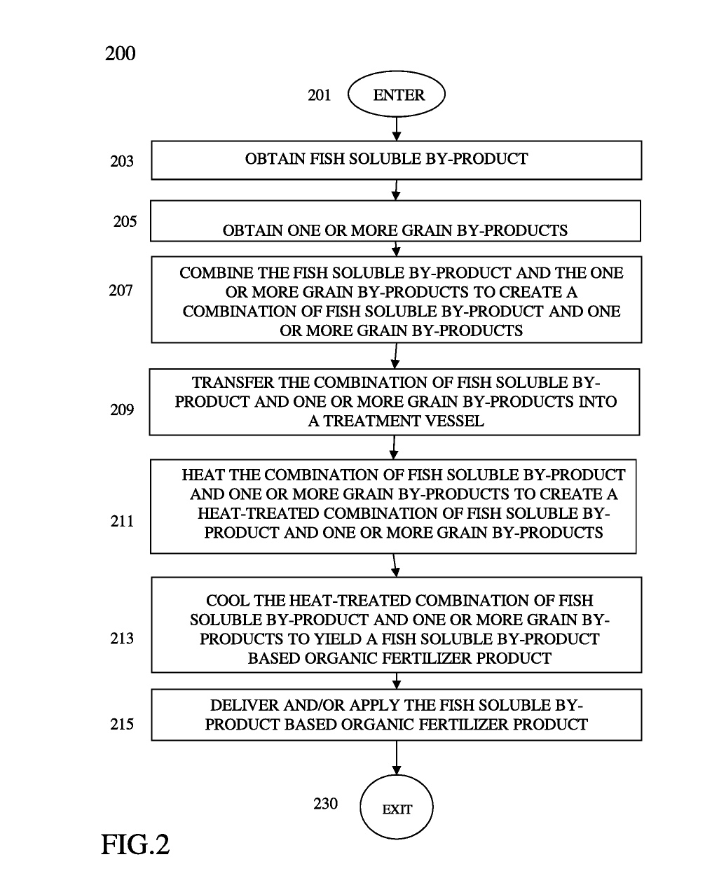

FIG. 2 is a flow chart of a process for creating a fish soluble by-product based organic fertilizer product from fish soluble by-product and one or more grain by-products, in accordance with one embodiment. As shown in FIG. 2, a process for production of a fish soluble by-product based organic fertilizer product from fish soluble by-product and one or more grain by-products 200 begins at ENTER OPERATION 201 and process flow proceeds to OBTAIN FISH SOLUBLE BY-PRODUCT OPERATION 203.

The fish soluble by-product of OBTAIN FISH SOLUBLE BY-PRODUCT OPERATION 203 is, as discussed above, a by-product of fish processing. In one embodiment, once the fish soluble by-product is obtained at OBTAIN FISH SOLUBLE BY-PRODUCT OPERATION 203, process flow proceeds to OBTAIN ONE OR MORE GRAIN BY-PRODUCTS OPERATION 205.

The one or more grain by-products of OBTAIN ONE OR MORE GRAIN BY-PRODUCTS OPERATION 205 include, but are not limited to, corn steep liquor, wet distillers grains, dried distillers grains with solubles, fermented grain solubles, corn condensed distillers solubles, and/or any other grain by-product as defined herein, known in the art at the time of filing, or developed thereafter. After one or more grain by-products are obtained at OBTAIN ONE OR MORE GRAIN BY-PRODUCTS OPERATION 205, process flow proceeds to COMBINE THE FISH SOLUBLE BY-PRODUCT AND THE ONE OR MORE GRAIN BY-PRODUCTS TO CREATE A COMBINATION OF FISH SOLUBLE BY-PRODUCT AND ONE OR MORE GRAIN BY-PRODUCTS OPERATION 207, in one embodiment. According to one embodiment, at COMBINE THE FISH SOLUBLE BY-PRODUCT AND THE ONE OR MORE GRAIN BY-PRODUCTS TO CREATE A COMBINATION OF FISH SOLUBLE BY-PRODUCT AND ONE OR MORE GRAIN BY-PRODUCTS OPERATION 207, at least a portion of the obtained fish soluble by-product and at least of a portion of the obtained one or more grain by-products are combined.

In one embodiment, the fish soluble by-product is combined with the one or more grain by-products such that the resulting combination of fish soluble by-product and one or more grain by-products is 10 percent to 90 percent fish soluble by-product. In one embodiment, the fish soluble by-product is combined with the one or more grain by-products such that the resulting combination of fish soluble by-product and one or more grain by-products is 10 percent to 90 percent grain by-products.

In other embodiments, at COMBINE THE FISH SOLUBLE BY-PRODUCT AND THE ONE OR MORE GRAIN BY-PRODUCTS TO CREATE A COMBINATION OF FISH SOLUBLE BY-PRODUCT AND ONE OR MORE GRAIN BY-PRODUCTS OPERATION 207, the fish soluble by-product is combined with the one or more grain by-products such that the resulting combination of fish soluble by-product and one or more grain by-products is any desired percentage concentration of fish soluble by-product, typically as determined by cost and the specific needs of the user.

In one embodiment, once the fish soluble by-product is combined with the one or more grain by-products at COMBINE THE FISH SOLUBLE BY-PRODUCT AND THE ONE OR MORE GRAIN BY-PRODUCTS TO CREATE A COMBINATION OF FISH SOLUBLE BY-PRODUCT AND ONE OR MORE GRAIN BY-PRODUCTS OPERATION 207 to yield the fish soluble by-product based organic fertilizer product, process flow proceeds to DELIVER AND/OR APPLY THE FISH SOLUBLE BY-PRODUCT BASED ORGANIC FERTILIZER PRODUCT OPERATION 215.

In one embodiment, once the fish soluble by-product and one or more grain by-products are combined at COMBINE THE FISH SOLUBLE BY-PRODUCT AND THE ONE OR MORE GRAIN BY-PRODUCTS TO CREATE A COMBINATION OF FISH SOLUBLE BY-PRODUCT AND ONE OR MORE GRAIN BY-PRODUCTS OPERATION 207, process flow proceeds to TRANSFER THE COMBINATION OF FISH SOLUBLE BY-PRODUCT AND ONE OR MORE GRAIN BY-PRODUCTS INTO A TREATMENT VESSEL OPERATION 209.

In various embodiments, at TRANSFER THE COMBINATION OF FISH SOLUBLE BY-PRODUCT AND ONE OR MORE GRAIN BY-PRODUCTS INTO A TREATMENT VESSEL OPERATION 209, at least a portion of the combination of fish soluble by-product and one or more grain by-products is transferred into one or more treatment vessels.

In one embodiment, at TRANSFER THE COMBINATION OF FISH SOLUBLE BY-PRODUCT AND ONE OR MORE GRAIN BY-PRODUCTS INTO A TREATMENT VESSEL OPERATION 209, the combination of fish soluble by-product and one or more grain by-products is filtered as the combination of fish soluble by-product and one or more grain by-products is disposed into the treatment vessel. In one embodiment, this filtering is optional. For example, the combination of fish soluble by-product and one or more grain by-products may not be filtered if the amount of suspended particulate matter is minimal. If pre-treatment filtration is desired, a stainless steel, or other suitable material, mesh having a mesh size number between 50 and 200 may be employed. In one embodiment, the mesh size is 200.

In one embodiment, once at least a portion of the combination of fish soluble by-product and one or more grain by-products is placed in one or more treatment vessels at TRANSFER THE COMBINATION OF FISH SOLUBLE BY-PRODUCT AND ONE OR MORE GRAIN BY-PRODUCTS INTO A TREATMENT VESSEL OPERATION 209, process flow proceeds to HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211.

In one embodiment, at HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211, at least a portion of the combination of fish soluble by-product and one or more grain by-products of COMBINE THE FISH SOLUBLE BY-PRODUCT AND THE ONE OR MORE GRAIN BY-PRODUCTS TO CREATE A COMBINATION OF FISH SOLUBLE BY-PRODUCT AND ONE OR MORE GRAIN BY-PRODUCTS OPERATION 207 is mechanically heated.

In one embodiment, at HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211, heat is applied to the combination of fish soluble by-product and one or more grain by-products to raise the average temperature of the combination of fish soluble by-product and one or more grain by-products to at least 130 degrees F. This temperature range is known to inhibit pathogenic bacterial growth of the most common pathogens such as Escherichia coli O157:H7 and Salmonella.

In one embodiment, at HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211, the combination of fish soluble by-product and one or more grain by-products is maintained in the treatment vessel at or above 130 degrees F. for up to 4 hours. In one embodiment, at HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211, the combination of fish soluble by-product and one or more grain by-products is maintained in the treatment vessel at or above 130 degrees F. for at least 4 hours. In one embodiment, at HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211, the combination of fish soluble by-product and one or more grain by-products is maintained in the treatment vessel at or above 130 degrees F. for at least 24 hours to ensure uniform heat transfer to the combination of fish soluble by-product and one or more grain by-products. In one embodiment, filtration may be accomplished concurrently at HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211. In one embodiment, the heat-treatment of HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211 may be performed for 120 hours or more, if desired.

In one embodiment, water and/or other liquid may be blended with the combination of fish soluble by-product and one or more grain by-products at HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211 to meet the desired nitrogen per weight or volume requirements of the combination of fish soluble by-product and one or more grain by-products. In one embodiment, water and/or other liquid may also be used to recover losses due to evaporation during the heat-treatment process of HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211. Liquid blending is typically not required, but is rather an optional procedure.

In one embodiment, once at least a portion of the combination of fish soluble by-product and one or more grain by-products of COMBINE THE FISH SOLUBLE BY-PRODUCT AND THE ONE OR MORE GRAIN BY-PRODUCTS TO CREATE A COMBINATION OF FISH SOLUBLE BY-PRODUCT AND ONE OR MORE GRAIN BY-PRODUCTS OPERATION 207 is heat-treated in the treatment vessel of TRANSFER THE COMBINATION OF FISH SOLUBLE BY-PRODUCT AND ONE OR MORE GRAIN BY-PRODUCTS INTO A TREATMENT VESSEL OPERATION 209 at HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211 to create a heat-treated combination of fish soluble by-product and one or more grain by-products, process flow proceeds to COOL THE HEAT-TREATED COMBINATION OF FISH SOLUBLE BY-PRODUCT AND ONE OR MORE GRAIN BY-PRODUCTS TO YIELD A FISH SOLUBLE BY-PRODUCT BASED ORGANIC FERTILIZER PRODUCT OPERATION 213.

In one embodiment, at COOL THE HEAT-TREATED COMBINATION OF FISH SOLUBLE BY-PRODUCT AND ONE OR MORE GRAIN BY-PRODUCTS TO YIELD A FISH SOLUBLE BY-PRODUCT BASED ORGANIC FERTILIZER PRODUCT OPERATION 213, the heat-treated combination of fish soluble by-product and one or more grain by-products of HEAT THE COMBINATION OF FISH SOLUBLE BY-PRODUCT AND ONE OR MORE GRAIN BY-PRODUCTS TO CREATE A HEAT-TREATED COMBINATION OF FISH SOLUBLE BY-PRODUCT AND ONE OR MORE GRAIN BY-PRODUCTS OPERATION 211 is allowed to cool in the treatment vessel of TRANSFER THE COMBINATION OF FISH SOLUBLE BY-PRODUCT AND ONE OR MORE GRAIN BY-PRODUCTS INTO A TREATMENT VESSEL OPERATION 209.

As noted, in one embodiment, the cooling at COOL THE HEAT-TREATED COMBINATION OF FISH SOLUBLE BY-PRODUCT AND ONE OR MORE GRAIN BY-PRODUCTS TO YIELD A FISH SOLUBLE BY-PRODUCT BASED ORGANIC FERTILIZER PRODUCT OPERATION 213 yields the resulting fish soluble by-product based organic fertilizer product.

In one embodiment, once the heat-treated combination of fish soluble by-product and one or more grain by-products is cooled at COOL THE HEAT-TREATED COMBINATION OF FISH SOLUBLE BY-PRODUCT AND ONE OR MORE GRAIN BY-PRODUCTS TO YIELD A FISH SOLUBLE BY-PRODUCT BASED ORGANIC FERTILIZER PRODUCT OPERATION 213 to yield the fish soluble by-product based organic fertilizer product, process flow proceeds to DELIVER AND/OR APPLY THE FISH SOLUBLE BY-PRODUCT BASED ORGANIC FERTILIZER PRODUCT OPERATION 215.

In one embodiment, at DELIVER AND/OR APPLY THE FISH SOLUBLE BY-PRODUCT BASED ORGANIC FERTILIZER PRODUCT OPERATION 215 the fish soluble by-product based organic fertilizer product is transferred in bulk to a tanker truck and/or transferred into drums for delivery of smaller quantities of the fish soluble by-product based organic fertilizer product. In one embodiment, at DELIVER AND/OR APPLY THE FISH SOLUBLE BY-PRODUCT BASED ORGANIC FERTILIZER PRODUCT OPERATION 215, the fish soluble by-product based organic fertilizer product is then delivered to farms for application to agricultural vegetation.

In one embodiment, at DELIVER AND/OR APPLY THE FISH SOLUBLE BY-PRODUCT BASED ORGANIC FERTILIZER PRODUCT OPERATION 215, a quantity of the fish soluble by-product based organic fertilizer product is offloaded into plastic field tanks located at or near the application site. In one embodiment, at DELIVER AND/OR APPLY THE FISH SOLUBLE BY-PRODUCT BASED ORGANIC FERTILIZER PRODUCT OPERATION 215, the plastic field tanks are then used to feed the fish soluble by-product based organic fertilizer product into the irrigation stream either by direct injection or by vacuum drawing from the irrigation flow.

Depending on the particular agricultural vegetation requirements, the application rate of fish soluble by-product based organic fertilizer product at DELIVER AND/OR APPLY THE FISH SOLUBLE BY-PRODUCT BASED ORGANIC FERTILIZER PRODUCT OPERATION 215 may be anywhere in a range of approximately 5 to 900 gallons per acre.

In one embodiment, at DELIVER AND/OR APPLY THE FISH SOLUBLE BY-PRODUCT BASED ORGANIC FERTILIZER PRODUCT OPERATION 215, the fish soluble by-product based organic fertilizer product may also be directly sprayed onto the agricultural vegetation without concerns of plant burning as may occur with more concentrated inorganic fertilizers.

In one embodiment, once the fish soluble by-product based organic fertilizer product is delivered and applied at DELIVER AND/OR APPLY THE FISH SOLUBLE BY-PRODUCT BASED ORGANIC FERTILIZER PRODUCT OPERATION 215, process flow proceeds to EXIT OPERATION 230 and the process for production of a fish soluble by-product based organic fertilizer product from fish soluble by-product and one or more grain by-products 200 is exited.

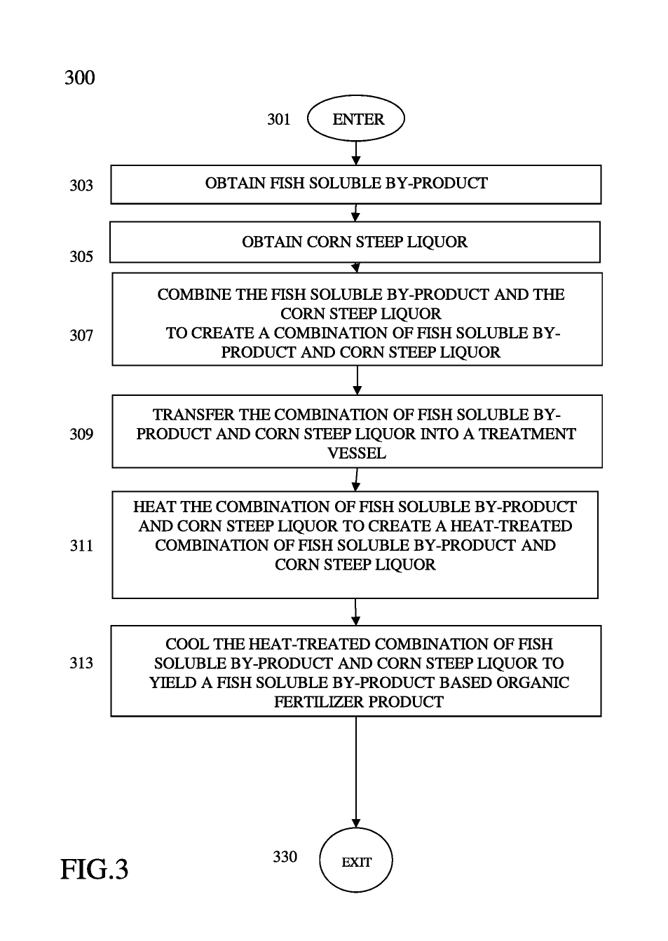

FIG. 3 is a flow chart of a process for creating a fish soluble by-product based organic fertilizer product from fish soluble by-product and corn steep liquor, in accordance with one embodiment. As shown in FIG. 3, a process for production of a fish soluble by-product based organic fertilizer product from fish soluble by-product and corn steep liquor 300 begins at ENTER OPERATION 301 and process flow proceeds to OBTAIN FISH SOLUBLE BY-PRODUCT OPERATION 303.

The fish soluble by-product of OBTAIN FISH SOLUBLE BY-PRODUCT OPERATION 303 is, as discussed above, a by-product of fish processing. In one embodiment, once the fish soluble by-product is obtained at OBTAIN FISH SOLUBLE BY-PRODUCT OPERATION 303, process flow proceeds to OBTAIN CORN STEEP LIQUOR OPERATION 305.

In one embodiment, the corn steep liquor of OBTAIN CORN STEEP LIQUOR OPERATION 305 is a by-product of corn wet-milling and is readily available. In various embodiments, corn steep liquor includes, but is not limited to, corn steepwater, light steepwater, heavy steepwater, and condensed fermented corn extractives. As a valuable nitrogen source, when combined with fish soluble by-products, corn steep liquor alters the NPK value of the resulting fish soluble by-product based organic fertilizer.

After corn steep liquor is obtained at OBTAIN CORN STEEP LIQUOR OPERATION 305, process flow proceeds to COMBINE THE FISH SOLUBLE BY-PRODUCT AND THE CORN STEEP LIQUOR TO CREATE A COMBINATION OF FISH SOLUBLE BY-PRODUCT AND CORN STEEP LIQUOR OPERATION 307, in one embodiment. According to one embodiment, at COMBINE THE FISH SOLUBLE BY-PRODUCT AND THE CORN STEEP LIQUOR TO CREATE A COMBINATION OF FISH SOLUBLE BY-PRODUCT AND CORN STEEP LIQUOR OPERATION 307, at least a portion of the obtained fish soluble by-product and at least of a portion of the obtained corn steep liquor are combined.

In one embodiment, the fish soluble by-product is combined with the corn steep liquor such that the resulting combination of fish soluble by-product and corn steep liquor is 10 percent to 90 percent fish soluble by-product. In one embodiment, the fish soluble by-product is combined with the corn steep liquor such that the resulting combination of fish soluble by-product and corn steep liquor is 10 percent to 90 percent corn steep liquor.

In other embodiments, at COMBINE THE FISH SOLUBLE BY-PRODUCT AND THE CORN STEEP LIQUOR TO CREATE A COMBINATION OF FISH SOLUBLE BY-PRODUCT AND CORN STEEP LIQUOR OPERATION 307, the fish soluble by-product is combined with the corn steep liquor such that the resulting combination of fish soluble by-product and corn steep liquor is any desired percentage concentration of fish soluble by-product, typically as determined by cost and the specific needs of the user.

In one embodiment, at COMBINE THE FISH SOLUBLE BY-PRODUCT AND THE CORN STEEP LIQUOR TO CREATE A COMBINATION OF FISH SOLUBLE BY-PRODUCT AND CORN STEEP LIQUOR OPERATION 307, the fish soluble by-product is combined with the corn steep liquor to yield the fish soluble by-product based organic fertilizer product.

In one embodiment, once the fish soluble by-product is combined with the corn steep liquor to yield the fish soluble by-product based organic fertilizer product at COMBINE THE FISH SOLUBLE BY-PRODUCT AND THE CORN STEEP LIQUOR TO CREATE A COMBINATION OF FISH SOLUBLE BY-PRODUCT AND CORN STEEP LIQUOR OPERATION 307, process flow proceeds to EXIT OPERATION 330 and the process for production of a fish soluble by-product based organic fertilizer product from fish soluble by-product and corn steep liquor 300 is exited.

In one embodiment, once the fish soluble by-product and corn steep liquor are combined at COMBINE THE FISH SOLUBLE BY-PRODUCT AND THE CORN STEEP LIQUOR TO CREATE A COMBINATION OF FISH SOLUBLE BY-PRODUCT AND CORN STEEP LIQUOR OPERATION 307, process flow proceeds to TRANSFER THE COMBINATION OF FISH SOLUBLE BY-PRODUCT AND CORN STEEP LIQUOR INTO A TREATMENT VESSEL OPERATION 309.

In various embodiments, at TRANSFER THE COMBINATION OF FISH SOLUBLE BY-PRODUCT AND CORN STEEP LIQUOR INTO A TREATMENT VESSEL OPERATION 309, at least a portion of the combination of fish soluble by-product and corn steep liquor is transferred into one or more treatment vessels.

In one embodiment, at TRANSFER THE COMBINATION OF FISH SOLUBLE BY-PRODUCT AND CORN STEEP LIQUOR INTO A TREATMENT VESSEL OPERATION 309, the combination of fish soluble by-product and corn steep liquor is filtered as the combination of fish soluble by-product and corn steep liquor is disposed into the treatment vessel. In one embodiment, this filtering is optional. If pre-treatment filtration is desired, a stainless steel, or other suitable material, mesh having a mesh size number between 50 and 200 may be employed. In one embodiment, the mesh size is 200.

In one embodiment, once at least a portion of the combination of fish soluble by-product and corn steep liquor is placed in one or more treatment vessels at TRANSFER THE COMBINATION OF FISH SOLUBLE BY-PRODUCT AND CORN STEEP LIQUOR INTO A TREATMENT VESSEL OPERATION 309, process flow proceeds to HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311.

In one embodiment, at HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311, at least a portion of the combination of fish soluble by-product and corn steep liquor of COMBINE THE FISH SOLUBLE BY-PRODUCT AND THE CORN STEEP LIQUOR TO CREATE A COMBINATION OF FISH SOLUBLE BY-PRODUCT AND CORN STEEP LIQUOR OPERATION 307 is mechanically heated.

In one embodiment, at HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311, heat is optionally applied to the combination of fish soluble by-product and corn steep liquor to raise the average temperature of the combination of fish soluble by-product and corn steep liquor to at least 130 degrees F.

In one embodiment, at HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311, the combination of fish soluble by-product and corn steep liquor is maintained in the treatment vessel at or above 130 degrees F. for up to 4 hours. In one embodiment, at HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311, the combination of fish soluble by-product and corn steep liquor is maintained in the treatment vessel at or above 130 degrees F. for at least 4 hours. In one embodiment, at HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311, the combination of fish soluble by-product and corn steep liquor is maintained in the treatment vessel at or above 130 degrees F. for at least 24 hours to ensure uniform heat transfer to the combination of fish soluble by-product and corn steep liquor. In one embodiment, the heat-treatment of HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311 may be performed for 120 hours or more, if desired.

In one embodiment, water may be blended with the combination of fish soluble by-product and corn steep liquor at HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311 to meet the desired nitrogen per weight or volume requirements of the combination of corn steep liquor and fish soluble by-product. In one embodiment, water may also be used to recover losses due to evaporation during the heat-treatment process of HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311.

In one embodiment, once at least a portion of the combination of fish soluble by-product and corn steep liquor of COMBINE THE FISH SOLUBLE BY-PRODUCT AND THE CORN STEEP LIQUOR TO CREATE A COMBINATION OF FISH SOLUBLE BY-PRODUCT AND CORN STEEP LIQUOR OPERATION 307 is optionally heat-treated in the treatment vessel of TRANSFER THE COMBINATION OF FISH SOLUBLE BY-PRODUCT AND CORN STEEP LIQUOR INTO A TREATMENT VESSEL OPERATION 309 at HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311 to create a heat-treated combination of fish soluble by-product and corn steep liquor, process flow proceeds to COOL THE HEAT-TREATED COMBINATION OF FISH SOLUBLE BY-PRODUCT AND CORN STEEP LIQUOR TO YIELD A FISH SOLUBLE BY-PRODUCT BASED ORGANIC FERTILIZER PRODUCT OPERATION 313.

In one embodiment, at COOL THE HEAT-TREATED COMBINATION OF FISH SOLUBLE BY-PRODUCT AND CORN STEEP LIQUOR TO YIELD A FISH SOLUBLE BY-PRODUCT BASED ORGANIC FERTILIZER PRODUCT OPERATION 313, the heat-treated combination of fish soluble by-product and corn steep liquor of HEAT THE COMBINATION OF FISH SOLUBLE BY-PRODUCT AND CORN STEEP LIQUOR TO CREATE A HEAT-TREATED COMBINATION OF FISH SOLUBLE BY-PRODUCT AND CORN STEEP LIQUOR OPERATION 311 is allowed to cool in the treatment vessel of TRANSFER THE COMBINATION OF FISH SOLUBLE BY-PRODUCT AND CORN STEEP LIQUOR INTO A TREATMENT VESSEL OPERATION 309.

As noted, in one embodiment, the cooling at COOL THE HEAT-TREATED COMBINATION OF FISH SOLUBLE BY-PRODUCT AND CORN STEEP LIQUOR TO YIELD A FISH SOLUBLE BY-PRODUCT BASED ORGANIC FERTILIZER PRODUCT OPERATION 313 yields the resulting fish soluble by-product based organic fertilizer product.

In one embodiment, once the heat-treated combination of fish soluble by-product and corn steep liquor is cooled at COOL THE HEAT-TREATED COMBINATION OF FISH SOLUBLE BY-PRODUCT AND CORN STEEP LIQUOR TO YIELD A FISH SOLUBLE BY-PRODUCT BASED ORGANIC FERTILIZER PRODUCT OPERATION 313 to yield the fish soluble by-product based organic fertilizer product, process flow proceeds to EXIT OPERATION 330 and the process for production of a fish soluble by-product based organic fertilizer product from fish soluble by-product and corn steep liquor 300 is exited.

Using the processes described above, a fish soluble by-product based organic fertilizer product is provided that is environmentally benign; is non-pathogenic; is derived from natural organic sources; does not require significant processing; has minimal odor; has a low viscosity liquid form; can be applied directly to agricultural vegetation; can be injected and/or added into irrigation streams; includes time-released nitrogen components which become bioavailable to agricultural vegetation by beneficial microbial digestion in soil; and eliminates chemical crop burning.

It should be noted that the language used in the specification has been primarily selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In the discussion above, certain aspects of one embodiment include process steps and/or operations described herein for illustrative purposes in a particular order and/or grouping. However, the particular order and/or grouping shown and discussed herein are illustrative only and not limiting. Those of skill in the art will recognize that other orders and/or grouping of the process steps and/or operations are possible and, in some embodiments, one or more of the process steps and/or operations discussed above can be combined and/or deleted. In addition, portions of one or more of the process steps and/or operations can be re-grouped as portions of one or more other of the process steps and/or operations discussed herein. Consequently, the particular order and/or grouping of the process steps and/or operations discussed herein do not limit the scope of the invention as claimed below.

In addition, the operations shown in the figures are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A process of manufacturing a fish soluble by-product based organic fertilizer product comprising:
obtaining a quantity of fish soluble by-product;
obtaining a quantity of one or more grain by-products; and
combining at least part of the quantity of the fish soluble by-product and at least part of the quantity of the one or more grain by-products.

2. The process of manufacturing the fish soluble by-product based organic fertilizer product of claim 1, wherein at least one of the one or more grain by-products includes one or more grain by-products from the following group of grain by-products:
corn steep liquor,
wet distillers grains,
dried distillers grains with solubles,
fermented grain solubles, and
corn condensed distillers solubles.

3. The process of manufacturing the fish soluble by-product based organic fertilizer product of claim 1, wherein at least one of the one or more grain by-products includes corn steep liquor.

4. The process of manufacturing the fish soluble by-product based organic fertilizer product of claim 1, wherein combining at least part of the quantity of the fish soluble by-product and at least part of the quantity of the one or more grain by-products grain by-product yields a combination of the fish soluble by-product and the one or more grain by-products; and further comprising:
heat-treating the combination of the fish soluble by-product and the one or more grain by-products to yield a heat-treated combination of the fish soluble by-product and the one or more grain by-products; and
cooling the heat-treated combination of the fish soluble by-product and the one or more grain by-products to yield the fish soluble by-product based organic fertilizer product.

5. The process of manufacturing the fish soluble by-product based organic fertilizer product of claim 1, wherein the fish soluble by-product is produced from fish and/or fish waste that has been subjected to one or more heating and/or evaporation processes.

6. The process of manufacturing the fish soluble by-product based organic fertilizer product of claim 1, wherein the fish soluble by-product based organic fertilizer product is 10 percent to 90 percent fish soluble by-product.

7. The process of manufacturing the fish soluble by-product based organic fertilizer product of claim 4, wherein heat-treating the combination of the fish soluble by-product and the one or more grain by-products to yield the heat-treated combination of the fish soluble by-product and the one or more grain by-products grain by-product comprises heating the combination of the fish soluble by-product and the one or more grain by-products to 130 degrees F.

8. The process of manufacturing the fish soluble by-product based organic fertilizer product of claim 1, further comprising:
filtering at least a part of the combination of the fish soluble by-product and the one or more grain by-products using a filter having a standard wire mesh size number in a range of 50 to 200.

9. The process of manufacturing the fish soluble by-product based organic fertilizer product of claim 4, further comprising:
filtering at least a portion of the heat-treated combination of the fish soluble by-product and the one or more grain by-products using a filter having a standard wire size number in a range of 50 to 200.

10. The process of manufacturing the fish soluble by-product based organic fertilizer product of claim 1, wherein the fish soluble by-product based organic fertilizer product includes a nitrogen content in a range of 1 to 10 percent.

11. The process of manufacturing the fish soluble by-product based organic fertilizer product of claim 1, wherein the fish soluble by-product based organic fertilizer product includes a phosphate content in a range of 0.5 to 2.5 percent.

12. The process of manufacturing the fish soluble by-product based organic fertilizer product of claim 1, wherein the fish soluble by-product based organic fertilizer product includes a potassium content in a range of 1 to 7 percent.

13. A fish soluble by-product based organic fertilizer product comprising:
a combination of fish soluble by-product and one or more grain by-products.

14. The fish soluble by-product based organic fertilizer product of claim 13, wherein the combination of fish soluble by-product and one or more grain by-products is subjected to a heat-treating process.

15. The fish soluble by-product based organic fertilizer product of claim 13, wherein the fish soluble by-product is produced from fish and/or fish waste that has been subjected to one or more heating and/or evaporation processes.

16. The fish soluble by-product based organic fertilizer product of claim 13, wherein at least one of the one or more grain by-products is corn steep liquor.

17. The fish soluble by-product based organic fertilizer product of claim 13, wherein at least one of the one or more grain by-products includes one or more grain by-products from the following group of grain by-products:
corn steep liquor,
wet distillers grains,
dried distillers grains with solubles,
fermented grain solubles, and
corn condensed distillers solubles.

18. The fish soluble by-product based organic fertilizer product of claim 13, wherein the fish soluble by-product based organic fertilizer product is 10 percent to 90 percent fish soluble by-product.

19. The fish soluble by-product based organic fertilizer product of claim 13, wherein the combination of the fish soluble by-product and the one or more grain by-products includes a nitrogen content in a range of 1 to 10 percent.

20. The fish soluble by-product based organic fertilizer product of claim 13, wherein the combination of the fish soluble by-product and the one or more grain by-products includes a phosphate content in a range of 0.5 to 2.5 percent.

21. The fish soluble by-product based organic fertilizer product of claim 13, wherein the combination of the fish soluble by-product and the one or more grain by-products includes a potassium content in a range of 1 to 7 percent.

22. A process for fertilization comprising:
obtaining a quantity of fish soluble by-product based organic fertilizer product, wherein the fish soluble by-product based organic fertilizer product is a combination of fish soluble by-product and one or more grain by-products; and
applying the fish soluble by-product based organic fertilizer product to the agricultural vegetation.

23. The process for fertilization of claim 22, wherein the combination of fish soluble by-product and one or more grain by-products is subjected to a heat-treating process.

24. The process for fertilization of claim 22, wherein the fish soluble by-product is produced from fish and/or fish waste that has been subjected to one or more heating and/or evaporation processes.

25. The process for fertilization of claim 22, wherein at least one of the one or more grain by-products is corn steep liquor.

26. The process for fertilization of claim 22, wherein at least one of the one or more grain by-products include one or more grain by-products from the following group of grain by-products:
corn steep liquor,
wet distillers grains,
dried distillers grains with solubles,
fermented grain solubles, and
corn condensed distillers solubles.

27. The process for fertilization of claim 22, wherein the fish soluble by-product based organic fertilizer product is 10 percent to 80 percent fish soluble by-product.

28. The process for fertilization of claim 22, wherein the combination of the fish soluble by-product based organic fertilizer product includes a nitrogen content in a range of 1 to 10 percent.

29. The process for fertilization of claim 22, wherein the fish soluble by-product based organic fertilizer product includes a phosphate content in a range of 0.5 to 2.5 percent.

30. The process for fertilization of claim 22, wherein the fish soluble by-product based organic fertilizer product includes a potassium content in a range of 1 to 7 percent.

31. The process for fertilization of claim 22, wherein applying the fish soluble by-product based organic fertilizer product to the agricultural vegetation comprises applying the fish soluble by-product based organic fertilizer product at a rate of 5 to 900 gallons per acre.

32. The process for fertilization of claim 22, wherein applying the fish soluble by-product based organic fertilizer product to the agricultural vegetation comprises applying/adding the fish soluble by-product based organic fertilizer product directly to the agricultural vegetation and/or fields and/or soil and/or substrate supporting the agricultural vegetation.

33. The process for fertilization of claim 22, wherein applying the fish soluble by-product based organic fertilizer product to the agricultural vegetation comprises applying/adding the fish soluble by-product based organic fertilizer product to an irrigation system servicing the agricultural vegetation.

34. The process for fertilization of claim 22, wherein applying the fish soluble by-product based organic fertilizer product to the agricultural vegetation comprises adding the fish soluble by-product based organic fertilizer product to a liquid base to obtain a desired concentration of fish soluble by-product based organic fertilizer product.

35. The process for fertilization of claim 34 wherein the desired concentration of fish soluble by-product based organic fertilizer product is 10 percent to 90 percent.
